(19) United States
(12) Patent Application Publication
(10) Pub. No.: US 2012/0092308 A1
(43) Pub. Date: Apr. 19, 2012

(54) DISPLAY PANEL

(75) Inventors: CHIA-MING CHIANG, Bade City (TW); Szu-lin Yen, Ruifang Township (TW)

(73) Assignee: CHUNGHWA PICTURE TUBES, LTD., Bade City (TW)

(21) Appl. No.: 13/008,812

(22) Filed: Jan. 18, 2011

(30) Foreign Application Priority Data
Oct. 15, 2010 (TW) 099219998

(51) Int. Cl. G09G 5/00

(52) U.S. Cl. 345/204

(57) ABSTRACT

A display panel comprises a display area having a plurality of pixel units for displaying images; a driving circuit for driving the pixel units and being arranged outside the display area; a plurality of signal lines having unequal resistances, and being electrically connected between the display area and the driving circuit for transmitting signals; and a plurality of layer jumpers for compensating the resistances of the signal lines and being disposed on the signal lines so that each of the signal lines having a compensated resistance, wherein the layer jumpers are utilized for making the compensated resistances of the respective signal lines to match each other. The display panel is capable of improving image display quality and providing a higher efficiency of resistance compensation for a unit of layout space.

### TECHNICAL FIELD OF THE INVENTION

The present invention relates to a display panel, and more particularly, to a display panel having layer jumpers disposed thereon for compensating resistances of signal lines.

### BACKGROUND OF THE INVENTION

Flat panel displays (FPDs) have become mainstream products in the market. More and more types of FPDs are developed and marketed, such as liquid crystal displays (LCDs), organic light emitted diode (OLED) displays, plasma display panels (PDPs), and field emission displays (FEDs). The problem usually occurred in these displays is that transmitting quality of scan signals or data signals is poor so as to affect image display quality.

Generally, signal lines between a driving circuit and a display area have different lengths. Since the lengths of the signal lines are not identical, a problem of inconsistent resistances is arisen. This may affect the signal transmitting quality, cause non-uniform brightness of the display area, and lead to poor image performance.

FIG. 1A is a schematic diagram showing a display panel 10 having a driving circuit and signal lines. Generally, the display panel 10 includes a display area 12, a driving circuit 14 which is disposed outside the display area 12, and a plurality of signal lines 102, 104, which are disposed between the display area 12 and the driving circuit 14 for transmitting signals therebetween. The display area 12 is a region for displaying images. The display area 12 has a plurality of pixel units 123 formed by interlaced scan lines 121 and data lines 122. The signal lines 102, 104, can be classified into scan signal lines 102 and data signal lines 104 respectively corresponding to the scan lines 121 and the data lines 122. The driving circuit 14 is utilized for driving the pixel units 123. The driving circuit 14 outputs control signals and data signals, and these signals are transmitted by the scan signal lines 102 and the data signal lines 104 to the respective pixel units 123 of the display area 12 for revealing the desired colors and displaying images. In addition, the driving circuit 14 can be implemented by integrated circuits (ICs) or implemented on a flexible printed circuit (FPC) substrate.

FIG. 1B is a schematic diagram showing another display panel having two driving circuits and signal lines. The difference between FIGS. 1A and 1B is that the display panel 10′ shown in FIG. 1B has two driving circuits, i.e. a gate driving circuit 16′ and a source driving circuit 14′. The gate driving circuit 16′ outputs control signals which are transmitted by the scan signal lines 102 to the scan lines 121. The source driving circuit 14′ outputs data signals which are transmitted by the data signal lines 104 to the data lines 122. In addition, the gate driving circuit 16′ and the source driving circuit 14′ can be implemented by ICs or implemented on an FPC substrate.

Generally, the respective signal lines 102 (or 104) have different lengths. The lengths of the signal lines 102 (or 104) are not the same. The outer signal lines of the scan signal lines 102 and the data signal lines 104 are longer than the inner signal lines. For example, as shown in FIGS. 2A and 2B, the length of the Nth signal line (102 or 104) is longer than that of the Mth signal line (102 or 104). Therefore, the resistance of the Nth signal line will be greater than that of the Mth signal line. When the value difference between N and M is the greatest, the resistance difference between the corresponding two signal lines will be at maximum.

Since the resistances of the respective scan signal lines 102 are non-uniform, this will cause a time deviation when driving the scan signals. Also, the resistances of the respective data signal lines 104 are non-uniform. This leads to poor transmission quality of the data signals, and may also cause image distortion. Both of the two situations will cause non-uniform brightness of the display area 12, and lead to poor display quality.

Referring to FIGS. 3A and 3B, a conventional display panel 30 is disclosed in U.S. Pat. No. 6,879,367. This prior art utilizes sinuous wires to compensate the resistance differences caused by different lengths of signal lines. FIG. 3A is a schematic diagram showing the conventional display panel 30. FIG. 3B is a schematic structural diagram showing signal lines 302 shown in FIG. 3A. As shown in FIG. 3A, the display panel 30 includes a display area 32, a driving circuit 34 which is disposed outside the display area 32, and a plurality of signal lines 302 which is disposed between the display area 32 and the driving circuit 34 for transmitting signals therebetween. The display area 32 has a plurality of pixel units 323 which are formed by interlaced scan lines 321 and data lines 322. The functions of the display area 32, the driving circuit 34, and the signal lines 302 are the same as the similar elements described above, and thereby are omitted herein. As shown in FIG. 3B, the length (L′) of the sinuous wire set in the Mth signal line is arranged longer than the length (L) of the sinuous wire set in the Nth signal line for compensating the resistance difference between the Mth signal line and the Nth signal line. Consequently, the length of the Mth signal line incorporated with the sinuous wire (L′) is substantially same as the length of the Nth signal line incorporated with the sinuous wire (L) so as to achieve the resistance compensation.

However, in the conventional resistance compensation, the lengths of the sinuous wires (L, L′) will be limited by a width of a terminal portion and is not suitable for some types or sizes of display panels. The conventional skill can not make sure that the resistance of the inner-most signal line matches the resistance of the outer-most signal line for all conditions. In addition, the resistance compensation ability per unit length or density is limited in the conventional skill which has disadvantages or drawbacks when developing high density or high resolution display panels.

### SUMMARY OF THE INVENTION

An objective of the present invention is to provide a display panel for solving the problem of non-uniform brightness of display area caused by poor signal transmission quality and thereby improving image display quality.

Another objective of the present invention is to provide a display panel for providing a higher efficiency of resistance compensation for a unit of layout space.

According to the above objectives, the present invention provides a display panel, which comprises: a display area having a plurality of pixel units for displaying images; a driving circuit for driving the pixel units and being arranged outside the display area; a plurality of signal lines having unequal resistances, and being electrically connected between the display area and the driving circuit for transmitting signals; and a plurality of layer jumpers for compensating the resistances of the signal lines and being disposed on the signal lines so that each of the signal lines having a compensated resistance, wherein the layer jumpers are utilized for making the compensated resistances of the respective signal lines to match each other.

In one embodiment, an area of each layer jumper is inversely proportional to a resistance of the same layer jumper. The greater is the resistance of one of the signal lines, the greater is the area of the layer jumpers being disposed thereon. Conversely, the smaller is the resistance of one of the signal lines, the smaller is the area of the layer jumpers being disposed thereon.

In another embodiment, the layer jumpers which are used for compensating the resistances of the signal lines are of the same area, and the greater is the resistance of one of the signal lines, the fewer the layer jumpers are disposed thereon, and conversely, the smaller is the resistance of one of the signal lines, the more the layer jumpers are disposed thereon.

Each layer jumper comprises a first metal layer, a second metal layer, and a first oxide layer, and has a first contact hole and a second contact hole. The first oxide layer is electrically connected to the first metal layer and the second metal layer via the first contact hole and the second contact hole, respectively. The first oxide layer may comprise an indium tin oxide layer. The area of each layer jumper is determined by contact areas between the first oxide layer and the first metal layer, and between the first oxide layer and the second metal layer. In addition, any one of the signal lines can be formed by stretching the first metal layer or the second metal layer.

In the present invention, layer jumpers are disposed on the signal lines of the display panel. The present invention utilizes different quantities or different sizes of areas of the layer jumpers for compensating resistances of the signal lines, making the compensated resistances of the signal lines to match each other so that the compensated resistances of the signal lines having the layer jumpers disposed thereon are substantially equal to each other. The present invention can provide a higher efficiency of resistance compensation for a unit of layout space. In a limited width of terminal portion, the present invention is capable of efficiently compensating the resistance differences between signal lines.

### BRIEF DESCRIPTION OF THE DRAWINGS

The present invention will be described in details in conjunction with the appending drawings.

FIG. 1A is a schematic diagram showing a display panel having a driving circuit and signal lines.

FIG. 1B is a schematic diagram showing another display panel having two driving circuits and signal lines.

FIG. 2A is a schematic diagram showing outer data signal lines are longer than inner data signal lines.

FIG. 2B is a schematic diagram showing outer scan signal lines are longer than inner scan signal lines.

FIG. 3A is a schematic diagram showing a conventional display panel.

FIG. 3B is a schematic structural diagram showing signal lines which are shown in FIG. 3A.

FIG. 4A is a schematic diagram showing an arrangement of a driving circuit and signal lines in a display panel implemented according to the present invention.

FIG. 4B is a schematic diagram showing another arrangement of two driving circuits and signal lines in a display panel implemented according to the present invention.

FIG. 5A is a schematic diagram showing outer data signal lines are longer than inner data signal lines in the present invention.

FIG. 5B is a schematic diagram showing outer scan signal lines are longer than inner scan signal lines in the present invention.

FIG. 6A is a schematic diagram showing that the respective signal lines of the display panel having different quantities of layer jumpers being disposed thereon in the present invention, in which the layer jumpers are of the same area.

FIG. 6B is a schematic diagram showing that the respective signal lines of the display panels having the same quantities of layer jumpers being disposed thereon in the present invention, in which the layer jumpers are of different sizes of areas.

FIG. 7 is a schematic structural diagram showing a layer jumper of the present invention.

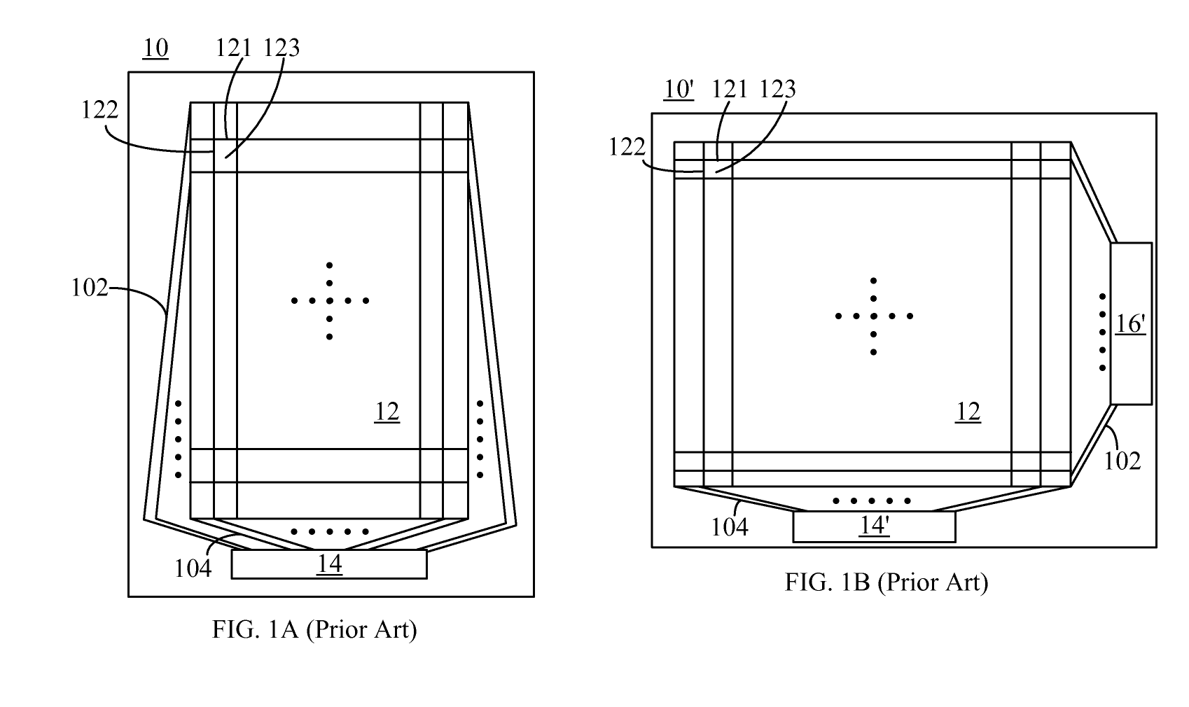

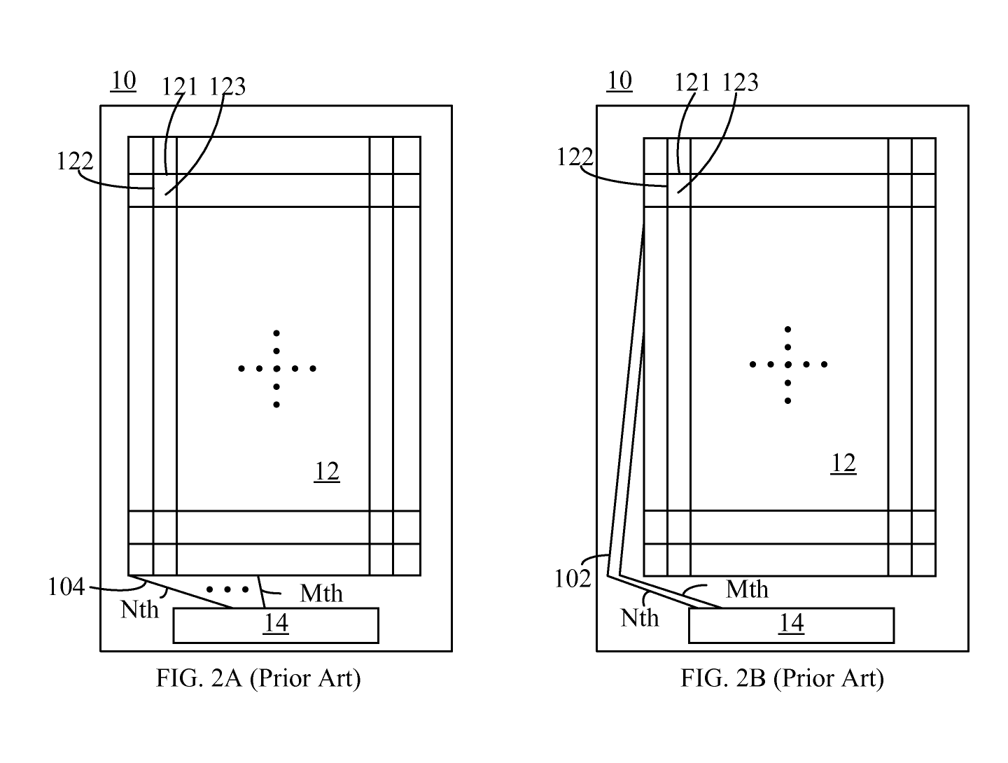

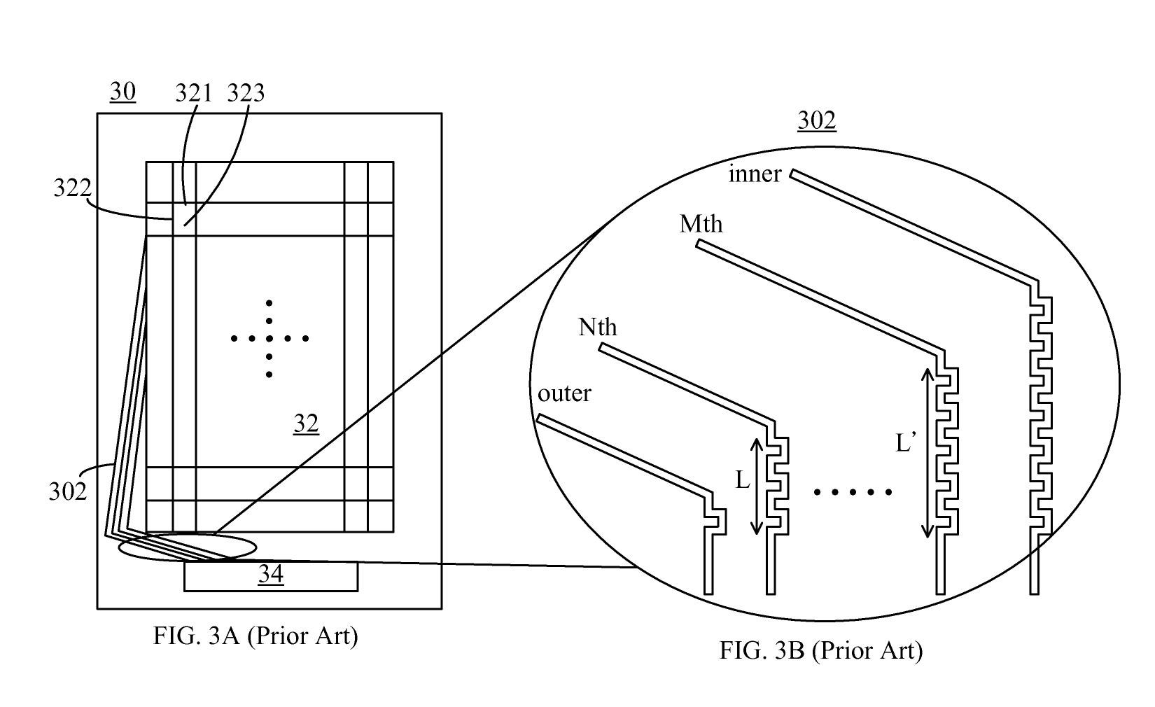

### DETAILED DESCRIPTION OF THE INVENTION

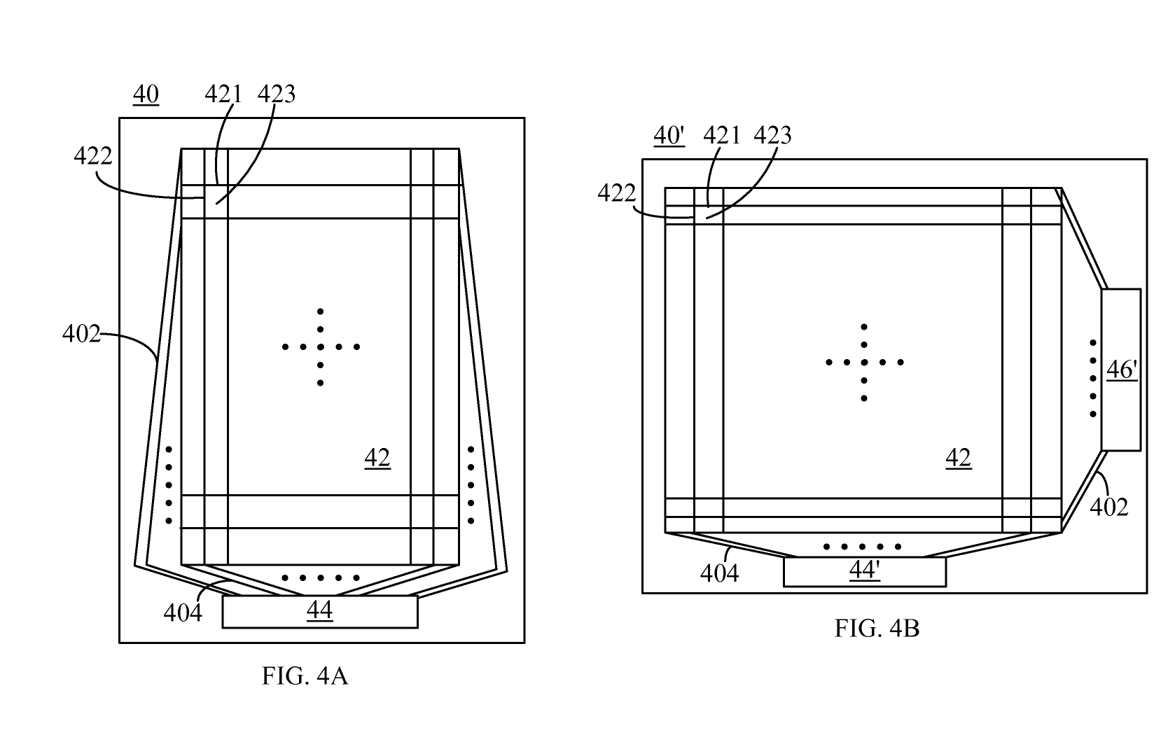

Please refer to FIGS. 4A, 4B, 5A, 5B, 6A, and 6B. In display panels 40, 40′, signal lines such as scan signal lines 402 and data signal lines 404 have layer jumpers 62 disposed thereon. The present invention utilizes different quantities or different sizes of areas of the layer jumpers 62 for compensating resistances of the signal lines 402, 404, making the compensated resistances of the respective signal lines 402, 404 to match each other so that the compensated resistances of the respective signal lines 402, 404, having the layer jumpers 62 disposed thereon are substantially equal to each other. The present invention is capable of solving the problem of non-uniform brightness of display area caused by poor signal transmitting quality and thereby improving image display quality. In the present invention, the display panels 40, 40′ can be implemented by liquid crystal displays (LCDs), organic light emitted diode (OLED) displays, plasma display panels (PDPs), and field emission displays (FEDs), and the likes.

As shown in FIG. 4A, the display panel 40 of the present invention includes a display area 42, a driving circuit 44, and a plurality of signal lines such as scan signal lines 402 and data signal lines 404. The display area 42 is a region for displaying images. The display area 42 has a plurality of pixel units 423 formed by interlaced scan lines 421 and data lines 422. The driving circuit 44 is arranged outside the display area 42 for driving the pixel units 423 to display images. The scan signal lines 402 and the data signal lines 404 are disposed between the display area 42 and the driving circuit 44, and are disposed respectively corresponding to the scan lines 421 and the data lines 422. The scan signal lines 402 and the data signal lines 404 are arranged for respectively connecting the scan lines 421 and the data lines 422 of the display area 42 to the driving circuit 44 for transmitting signals. The driving circuit 44 outputs control signals and data signals, and these signals are transmitted respectively by the scan signal lines 402 and the data signal lines 404 to the respective pixel units 423 of the display area 42 for displaying images. Further referring to FIG. 4B, the difference between FIGS. 4A and 4B is that driving circuits of a display panel 40′ shown in FIG. 4B are divided into a gate driving circuit 46′ and a source driving circuit 44′. The gate driving circuit 46′ outputs control signals and the control signals are transmitted by the scan signal lines 402 to the scan lines 421 of the display area 42. The source driving circuit 44′ outputs data signals and the data signals are transmitted by the data signal lines 404 to the data lines 422 of the display area 42. The gate driving circuit 46′ and the source driving circuit 44′ shown in FIG. 4B and the driving circuit 44 shown in FIG. 4A can be implemented by integrated circuits (ICs) or implemented on a flexible printed circuit (FPC) substrate. It is noted that the present invention is not limited to be implemented by the display panels 40, 40′ shown in FIGS. 4A and 4B. The technical scheme of utilizing layer jumpers for compensating the resistances of signal lines provided by the present invention also can be implemented by other display panels arranged in different manners.

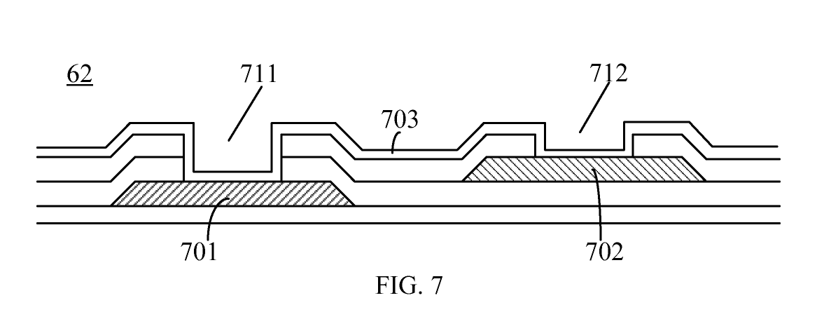

In the present invention, the layer jumpers 62 are disposed on the scan signal lines 402 and the data signal lines 404 of the display panels 40, 40′ so as to make the compensated resistances of the respective signal lines 402, 404 matching each other. FIG. 7 is a schematic structural diagram showing one layer jumper 62 of the present invention. The layer jumper 62 includes a first metal layer 701, a second metal layer 702, and a first oxide layer 703. The layer jumper 62 has two metal contact holes including a first contact hole 711 and a second contact hole 712. The first contact hole 711 is formed by opening an area above the first metal layer 701 and the second contact hole 712 is formed by opening an area above the second metal layer 702. The first oxide layer 703 is electrically connected to the first metal layer 701 and the second metal layer 702 via the first contact hole 711 and the second contact hole 712, respectively. The first oxide layer 703 may include an indium tin oxide layer. The material of the first metal layer 701 can be implemented by aluminum or other conductive materials. The material of the second metal layer 702 can be implemented by a composite metal material such as Mo/Al/Mo, or other applicable composite materials, or a single conductive material.

Since the first metal layer 701 and the first oxide layer 703 are of different materials, the contact surface therebetween leads to a larger resistance. Likewise, the contact surface between the second metal layer 702 and the first oxide layer 703 also leads to a larger resistance. Therefore, the layer jumper 62 can be utilized for compensating the resistances of the signal lines 402, 404. Moreover, the resistance of the layer jumper 62 is inversely proportional to the contact areas between two different layers. That is, the broader are the contact areas, the smaller is the resistance. Conversely, the smaller are the contact areas, the greater is the resistance. The resistance of the layer jumper 62 is determined at least by the contact areas, and the area of the layer jumper 62 can be defined by the contact areas between the first oxide layer 703 and the first metal layer 701 and between the first oxide layer 703 and the second metal layer 702. In addition, any one line of the signal lines 402, 404 can be formed by stretching the first metal layer 701 or the second metal layer 702. The signal lines 402, 404 also can be formed by other metal layers, and are respectively connected to the first metal layer 701 and the second metal layer 702 after being formed.

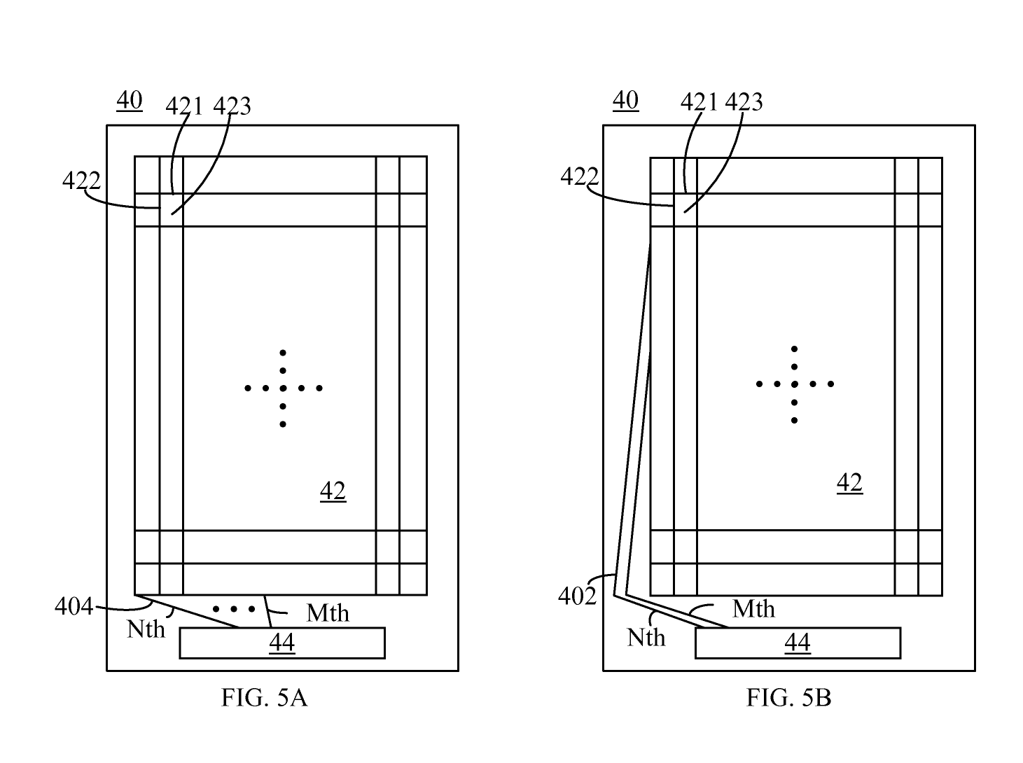

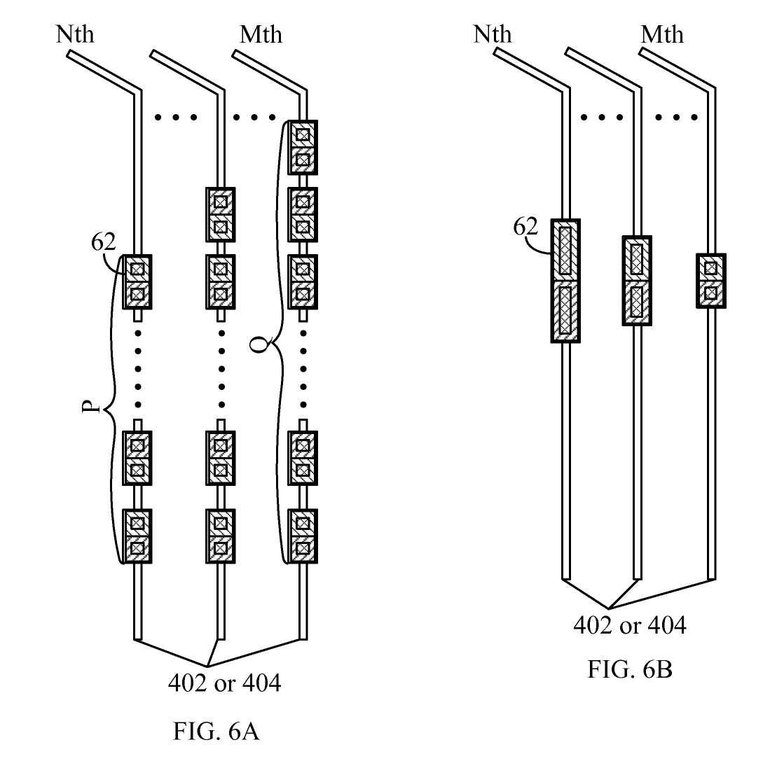

FIG. 6A is a schematic diagram showing the respective signal lines 402, 404 of the display panels 40, 40′ having different quantities of layer jumpers 62 being disposed thereon in the present invention, in which the layer jumpers 62 are of the same area. As shown in FIGS. 5A, 5B, and 6A, the outer signal lines are longer than the inner signal lines for the scan signal lines 402 or the data signal lines 404 regardless. For example, as shown in FIGS. 5A and 5B, the length of the Nth signal line is longer than that of the Mth signal line. That is to say, the resistance of the Nth signal line will be greater than that of the Mth signal line. In FIG. 6A, each layer jumper 62 has the same area and the same resistance as well. In the present invention, layer jumpers 62 of an appropriate quantity being connected in series are disposed on the respective signal lines 402 (or 404) for compensating the resistance differences between the signal lines 402 (or 404) so that the compensated resistances of the respective signal lines 402 (or 404) are substantially identical. If the layer jumpers 62 used for compensating the resistances of the signal lines 402 (or 404) are of the same area, the greater is the resistance of one of the signal lines 402 (or 404), the fewer the layer jumpers 62 are disposed thereon, and conversely, the smaller is the resistance of one of the signal lines 402 (or 404), the more the layer jumpers 62 are disposed thereon. Since the resistance of the Nth signal line is greater than that of the Mth signal line, the quantity of layer jumpers 62 provided for the Mth signal line must be larger than the quantity of layer jumpers 62 provided for the Nth signal line. Assuming that the Nth signal line is designed to have P layer jumpers 62 and the Mth signal line is designed to have Q layer jumpers 62, the values of P and Q can be appropriately calculated to efficiently achieve the resistance compensation of the signal lines. For example, assuming that the resistance (R1) of the Nth signal line is equal to 2500Ω, the resistance (R2) of the Mth signal line is equal to 1000Ω, and the contact resistance of the layer jumper 62 having an area A is 150Ω, it is necessary to dispose 10 pieces of the layer jumpers 62 on the Mth signal line for compensating the resistance of the Mth signal line, represented as follows:

R2′=R2+150Ω×10=1000Ω+1500Ω=2500Ω=R1,

wherein R2′ represents the total resistance of the Mth signal line compensated by 10 pieces of the layer jumpers 62, and said total resistances of the Mth signal line matches the resistance of the Nth signal line. It is noted that the present invention is not limited to dispose layer jumpers 62 of the same area on the signal lines 402 (or 404) for the case of disposing different quantities of layer jumpers 62 on each signal line 402 (or 404). Each signal line 402 (or 404) may have layer jumpers 62 of different sizes of areas disposed thereon. It merely has to make the compensated resistances of the signal lines 402 (or 404) matching each other.

FIG. 6B is a schematic diagram showing that the respective signal lines 402, 404 of the display panels 40, 40′ have the same quantities of layer jumpers 62 disposed thereon in the present invention, in which the layer jumpers 62 are of different sizes of areas. As shown in FIGS. 5A, 5B, and 6B, in the present invention, layer jumpers 62 of appropriate areas are disposed on the respective signal lines 402 (or 404) for compensating the resistance differences between the signal lines 402 (or 404) so that the compensated resistances of the respective signal lines 402 (or 404) are substantially identical. If the layer jumpers 62 disposed on each signal line 402 (or 404) are of the same quantity, the greater is the resistance of one of the signal lines 402 (or 404), the greater is the area of the layer jumper 62 being disposed thereon, and conversely, the smaller is the resistance of one of the signal lines 402 (or 404), the smaller is the area of the layer jumper 62 being disposed thereon. For example, as shown in FIGS. 5A and 5B, the area of the layer jumper 62 provided for the Mth signal line must be smaller than the area of the layer jumper 62 provided for the Nth signal line since the resistance of the Nth signal line is greater than that of the Mth signal line, and the area of the layer jumper 62 is inversely proportional to the resistance of the layer jumper 62. Assuming that the Nth signal line is designed to have a layer jumper of which the area is A and the resistance is R, and the Mth signal line is designed to have a layer jumper of which the area is A′ and the resistance is R′, the areas A and A′ can be adopted appropriately so as to correspondingly obtain the resistances R and R′ to efficiently achieve the resistance compensation of the signal lines. For example, assuming that the resistance (R1) of the Nth signal line is equal to 2500Ω, the resistance (R2) of the Mth signal line is equal to 1000Ω, and the contact resistance of the layer jumper having an area A is 150Ω; it is necessary to dispose a layer jumper of which the area is 1/10 (A) on the Mth signal line for making the compensated resistances of the Nth and Mth signal lines to match each other. It is noted that the present invention is not limited to dispose only one layer jumper 62 on each signal line 402 (or 404) for the case of disposing layer jumpers 62 of different sizes of areas on the signal lines 402 (or 404). Every two signal lines 402 (or 404) may have layer jumpers 62 of different quantities and sizes of areas disposed thereon. It merely has to make the compensated resistances of the signal lines 402 (or 404) matching each other.

The present invention can provide a higher efficiency of resistance compensation for a unit of layout space. In a limited width of terminal portion, the present invention is capable of efficiently compensating the resistance differences between signal lines to make the compensated resistances of the signal lines matching each other so that the compensated resistances of the signal lines are substantially equal to each other. Moreover, in the present invention, the materials of the first metal layer, the second metal layer, and the first oxide layer may be respectively the same as the materials of thin-film transistors and common electrodes, and can be manufactured in the same process, and thereby additional manufacturing costs are not required.

Taking small and medium display panels for example, limited terminal width and resistance differences between signal lines for different types of display panels are illustrated in the following table.

| | Quantity | The Resistance Difference | Width of | |
|---|---|---|---|---|
| Reso- | of Scan | Between the First And the | Terminal | |
| lution | Lines | Last Scan Lines (Ω) | Portion (μm) | *Note |
| 1.8″ | 160 | 5211 − 1724 = 3487 | 770 | Metal Layer |
| QQVGA | | | | |
| 2.4″ | 320 | 14993 − 3255 = 11738 | 1100 | ═MoNb |
| QVGA | | | | |
| 3.5″ | 800 | 20670 − 2913 = 17757 | 740 | 2350 Å |
| WVGA | | | | |

As can be seen, the larger is the size of the display panel, the greater is the resistance difference between the first scan line and the last scan line. For the three types of display panels, the aforesaid resistance differences all lie above 3000Ω. In another aspect, the width of terminal portion used for compensating the resistances of signal lines lies between 700 to 1100 μm, rather than increased with the size of display panel. Moreover, for the two different manners to compensate the resistances of signal lines, i.e. (1) utilizing sinuous wires in a prior art, and (2) utilizing layer jumpers in the present invention, the resistance compensation ability per unit length is a significant criterion to be compared in the two manners. For the wire arrangement in the prior art, the compensable resistance reaches 13Ω per unit length. For the layer jumper arrangement in the present invention, the compensable resistance lies between 100 to 200Ω per unit length. As can be seen, the present invention can provide a higher efficiency of resistance compensation for a limited width of terminal portion.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A display panel, comprising:
a display area having a plurality of pixel units for displaying images;
a driving circuit for driving the pixel units and being arranged outside the display area;
a plurality of signal lines having unequal resistances, and being electrically connected between the display area and the driving circuit for transmitting signals; and
a plurality of layer jumpers for compensating the resistances of the signal lines and being disposed on the signal lines so that each of the signal lines having a compensated resistance;
wherein the layer jumpers are utilized for making the compensated resistances of the respective signal lines to match each other.

2. The display panel according to claim 1, wherein an area of each layer jumper is inversely proportional to a resistance of the same layer jumper.

3. The display panel according to claim 2, wherein the greater is the resistance of one of the signal lines, the greater is the area of the layer jumpers being disposed thereon.

4. The display panel according to claim 2, wherein the smaller is the resistance of one of the signal lines, the smaller is the area of the layer jumpers being disposed thereon.

5. The display panel according to claim 1, wherein the layer jumpers which are used for compensating the resistances of the signal lines are of the same area, and the greater is the resistance of one of the signal lines, the fewer the layer jumpers are disposed thereon.

6. The display panel according to claim 1, wherein the layer jumpers which are used for compensating the resistances of the signal lines are of the same area, and the smaller is the resistance of one of the signal lines, the more the layer jumpers are disposed thereon.

7. The display panel according to claim 1, wherein each layer jumper comprises a first metal layer, a second metal layer, and a first oxide layer, the first oxide layer is electrically connected to the first metal layer and the second metal layer.

8. The display panel according to claim 7, wherein the area of each layer jumper is determined by contact areas between the first oxide layer and the first metal layer and between the first oxide layer and the second metal layer.

9. The display panel according to claim 7, wherein the first oxide layer comprises an indium tin oxide layer.

10. The display panel according to claim 7, wherein each layer jumper comprises a first contact hole and a second contact hole, the first oxide layer is electrically connected to the first metal layer and the second metal layer via the first contact hole and the second contact hole, respectively.

11. The display panel according to claim 1, wherein the compensated resistances of the signal lines having the layer jumpers disposed thereon are substantially equal to each other.
